(19) United States
(12) Patent Application Publication
(10) Pub. No.: US 2026/0127594 A1
(43) Pub. Date: May 7, 2026

(54) COMPUTER-BASED SYSTEMS CONFIGURED TO AUTOMATICALLY EXECUTE PROGRAMMED ROUTINES BASED ON PRE-DETERMINED EVENT TRIGGERS AND METHODS OF USE THEREOF

(71) Applicant: Capital One Services, LLC, McLean, VA (US)

(72) Inventors: Matthew Louis Nowak, Midlothian, VA (US); Robert Dwane Wokaty, JR., Glen Allen, VA (US); David Crawford, McLean, VA (US); Taylor Turner, Richmond, VA (US)

(21) Appl. No.: 18/936,702

(22) Filed: Nov. 4, 2024

(51) Int. Cl. G06Q 20/40; G06N 20/00

(52) U.S. Cl. CPC G06Q 20/40; G06N 20/00

(57) ABSTRACT

In some embodiments, the present disclosure provides an exemplary method that may include steps of obtaining usage data associated with a plurality of data sets over a predetermined period of time; determining a correlation between one data point in a plurality of data points associated with each data set within the usage data and an established usage baseline, the established usage baseline is associated with a historical data set; utilizing a trained machine learning module to dynamically generate a usage score for the plurality of data sets based on the correlation between the data point and the established usage baseline to form a prediction of usage data; and automatically modifying a particular data set of the plurality of data sets to form a modified data set, the modified data set comprising additional authentication steps to perform a plurality of actions.

### FIELD OF TECHNOLOGY

The present disclosure generally relates to computer-based systems configured to automatically execute programmed routines based on pre-determined event triggers and methods of use thereof.

### BACKGROUND OF TECHNOLOGY

Typically, the training of a machine learning model requires a computing device to gather and prepare data, select an appropriate machine learning algorithm, divide data into training and testing data sets, train the model using the training data and optimize parameters, and assess how well the model performs using the testing data.

### SUMMARY OF DESCRIBED SUBJECT MATTER

In some embodiments, the present disclosure may provide an exemplary technically improved computer-based method that includes at least the following steps: obtaining, by one or more processors, usage data associated with a user over a predetermined period of time; utilizing, by one or more processors, a trained machine learning module to determine a correlation between a particular data point within the usage data and an established usage baseline associated with the user; dynamically generating, by one or more processors, a recommendation for the user based on the correlation between the particular data point and the established usage baseline; and automatically applying, by one or more processors, the generated recommendation to an account of the user.

In some embodiments, the present disclosure may provide a technically-improved computer-based system that includes a processor capable of instructing at least the following steps: obtain usage data associated with a user over a predetermined period of time; utilize a trained machine learning module to determine a correlation between a particular data point within the usage data and an established usage baseline associated with the user; dynamically generate a recommendation for the user based on the correlation between the particular data point and the established usage baseline; and automatically apply the recommendation to an account of the user.

### BRIEF DESCRIPTION OF DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 depicts a block diagram of an exemplary computer-based system and platform for automatically applying a recommendation in response to identifying a plurality of transactions during a period of time, in accordance with one or more embodiments of the present disclosure.

FIG. 2 is a flowchart illustrating operational steps for automatically applying a generated recommendation to an account of a user, in accordance with one or more embodiments of the present disclosure.

FIG. 3 is a flowchart illustrating operational steps for dynamically modifying the application of the generated recommendation, in accordance with one or more embodiments of the present disclosure.

FIG. 4 depicts a block diagram of an exemplary computer-based system/platform in accordance with one or more embodiments of the present disclosure.

FIG. 5 depicts a block diagram of another exemplary computer-based system/platform in accordance with one or more embodiments of the present disclosure.

FIGS. 6 and 7 are diagrams illustrating implementations of cloud computing architecture/aspects with respect to which the disclosed technology may be specifically configured to operate, in accordance with one or more embodiments of the present disclosure.

### DETAILED DESCRIPTION

Various detailed embodiments of the present disclosure, taken in conjunction with the accompanying figures, are disclosed herein; however, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

In addition, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “and” and “or” may be used interchangeably to refer to a set of items in both the conjunctive and disjunctive in order to encompass the full description of combinations and alternatives of the items. By way of example, a set of items may be listed with the disjunctive “or”, or with the conjunction “and.” In either case, the set is to be interpreted as meaning each of the items singularly as alternatives, as well as any combination of the listed items.

It is understood that at least one aspect/functionality of various embodiments described herein can be performed in real-time and/or dynamically. As used herein, the term “real-time” is directed to an event/action that can occur instantaneously or almost instantaneously in time when another event/action has occurred. For example, the “real-time processing,” “real-time computation,” and “real-time execution” all pertain to the performance of a computation during the actual time that the related physical process (e.g., a creator interacting with an application on a mobile device) occurs, in order that results of the computation can be used in guiding the physical process.

As used herein, the term “dynamically” and term “automatically,” and their logical and/or linguistic relatives and/or derivatives, mean that certain events and/or actions can be triggered and/or occur without any human intervention. In some embodiments, events and/or actions in accordance with the present disclosure can be in real-time and/or based on a predetermined periodicity of at least one of: nanosecond, several nanoseconds, millisecond, several milliseconds, second, several seconds, minute, several minutes, hourly, daily, several days, weekly, monthly, etc.

As used herein, the term “runtime” corresponds to any behavior that is dynamically determined during an execution of a software application or at least a portion of a software application.

Embodiments of the present disclosure recognize at least one technological computer-centered problem associated with determining a usage value for an account of an individual and modifying the account based on the usage value exceeding a predetermined threshold. As used herein, in some embodiments, the term account risk may refer to an account associated with an individual that is commonly unpaid or exceeds a predetermined risk threshold. Typically, accounts with the account risk may be unable to receive a digital object capable of providing usage or may only receive a type of digital object that limits the provided usage due to a usage history or an account risk that fails to meet a predetermined threshold. For example, the digital object may refer to a points card may refer to a type of credit card that allows a user to earn points by making specific purchases, where issuers of this type of credit card typically offer different points rates for different types of purchases. The technical problem arises when a plurality of usage values associated with a plurality of accounts are commingled and increasingly difficult to track and identify data that are not labeled based on usage vales and prioritized in a way to identify usage values that exceed a predetermined threshold of account risk. In some instances, the user may require the points card to afford specific necessities to sustain survival. In some embodiments, the account parameters may refer to credit score, payment history, and annual income. Moreover, the issuer may utilize external data sources to predetermine whether the user would be considered an account risk. Embodiments of the present disclosure detail a computer-centric technological solution associated with the technological problem by utilizing a trained machine learning module to automatically weight a plurality of purchases; dynamically generating a recommendation based on the account of the user; and automatically applying the recommendation in response to identifying a particular purchase. In some embodiments, the trained machine learning module may refer to a need multiplier rules engine that automatically applies a value and/or weight to each type of purchase and automatically applies correlating points to the account of the user, where the earned points may be automatically applied to a balance associated with the account. In some embodiments, the trained machine learning module may identify bills and/or recurring charges within the usage data associated with the user. In some embodiments, the trained machine learning module may analyze the account of the user without comparison to a plurality of other users with similar account parameters. In some embodiments, an execution of a trained machine learning module may be dependent, at least in part, on a permission and/or opt-in from the user prior to the automatic application of earned points to the account associated with the user. In some embodiments, the trained machine learning module may modify the application of earned points based on an occurrence of an event and/or predetermined threshold being exceeded.

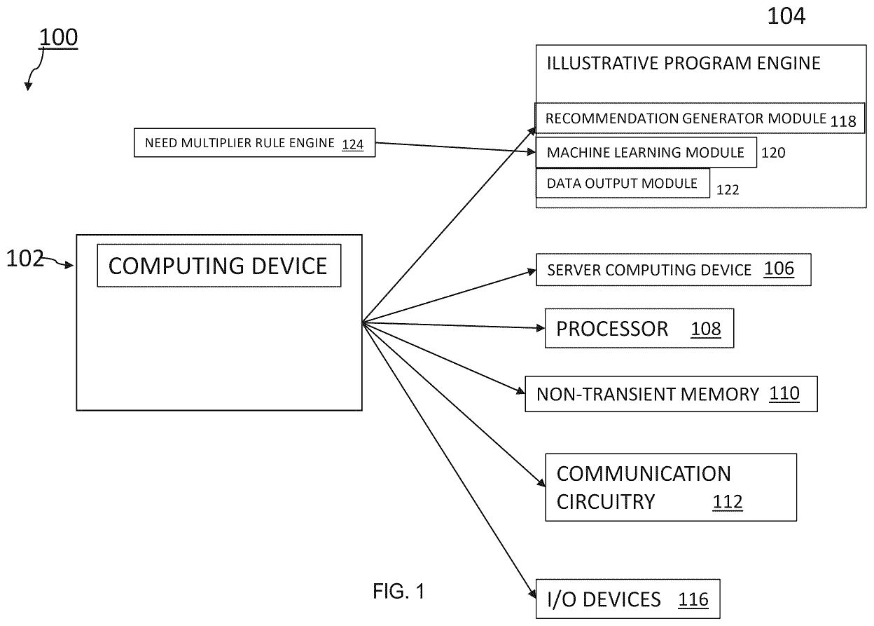

FIG. 1 depicts a block diagram of an exemplary computer-based system and platform for automatically applying a recommendation in response to identifying a plurality of transactions during a period of time, in accordance with one or more embodiments of the present disclosure.

In some embodiments, a computing system 100 may include a computing device 102 associated with a user and an illustrative program engine 104. In some embodiments, the program engine 104 may be stored on the computing device 102. In some embodiments, the illustrative program engine 104 may reside, partially or in full, on a server computing device 106 (not shown). In some embodiments, the computing device 102 may include a processor 108, a non-transient memory 110, a communication circuitry 112 for communicating over a communication network 114 (not shown), and input and/or output (I/O) devices 116 such as a keyboard, mouse, a touchscreen, and/or a display, for example. In certain embodiments, the computing device 102 may refer to a plurality of edge devices capable of communicating between each other.

In some embodiments, the illustrative program engine 104 may be configured to instruct the processor 108 to execute one or more software modules such as a recommendation generator module 118, machine learning model module 120, and a data output module 122.

In some embodiments, an exemplary recommendation generator module 118, of the present disclosure, utilizes at least one machine learning algorithm described herein, to generate a recommendation on an application of earned points to an account of a user based on a determined correlation of a plurality of transactions and an established baseline; automatically applying the recommendation to the account of the user, where the recommendation may redeem an earned point to a particular purchase; and dynamically modifying a subsequent application of the earned points to the account of the user based on an identification of a threshold being met and/or exceeded. Typically, the exemplary recommendation generator module 118 provides recommendations to a plurality of users based on common account parameters, where the common account parameters may refer to credit scores, payment history, and/or annual income. In some embodiments, the automatic application of generated recommendations may redeem outstanding balances associated with the account of the user, where the automatic application of generated recommendations may be based on an account profile of the user. In some embodiments, the recommendation generator module 118 may obtain usage data associated with the account of the user, where the usage data may contain financial information associated with the user. In certain embodiments, the financial information associated with the user may refer to typical spending habits, account balance, and account profile history. For example, the obtained usage data may refer to user-specific credit card usage data over a predetermined period of time. In some embodiments, the recommendation generator module 118 may store the user-specific usage data in an external data repository (i.e., database). In some embodiments, the predetermined period of time may refer to a time period that provides sufficient information to determine the account parameters associated with the user. In certain embodiments, the predetermined period of time may have a minimum range of hours and a maximum range of three months. In some embodiments, the recommendation generator module 118 may obtain the user-specific usage data by continuously monitoring activity associated with the account of the user, where the activity may refer to a plurality of transactions utilizing funds stored in the account of the user; identify a type of transaction associated with each transaction in the plurality of transactions and provide a type label to each transaction for optimizing storage within the server computing device 106; compare each transaction within a particular type of transaction to an aggregate rate matrix to assign a weight to each transaction for a proportional redeemable value based on the need multiplier rules engine 124. In some embodiments, the recommendation generator module 118 may determine a correlation between a user-specific usage data and an established usage baseline. In certain embodiments, the recommendation generator module 118 may determine the correlation utilizing the trained machine learning module 120 to compare the user-specific usage data to the established usage baseline. In certain embodiments, the trained machine learning module 120 may communicate with and/or house a need multiplier rules engine 124. The need multiplier rules engine 124 may refer to an executable program that may manage, execute, and monitor complex decision-making processes based on predefined rules. In some embodiments, the predefined rules associated with the recommendation generator module 118 may include types of purchases, purchases at or above a spending limit, and transfers between a plurality of accounts to prevent overdraft fees. In some embodiments, the recommendation generator module 118 may generate a recommendation, where the recommendation may provide a prediction on subsequent usage of the user based on the determined correlation between the user-specific usage data and the established baseline. In some embodiments, the recommendation may refer to an automatic redeemable value to the account of the user. In some embodiments, the recommendation generator module 118 may automatically apply the generated recommendation to the account of the user. In certain embodiments, the automatic application of the redeemable values to the account of the user. The redeemable value may refer to an earned point based on an identified purchase within the user-specific usage data, where each earned point refers to an identified transaction that aligns with a predetermined type of purchase and/or an account threshold associated with the account of the user. These predetermined types of purchases and account thresholds may also be included in the predefined rules of the trained machine learning module 120. In some embodiments, the recommendation generator module 118 may dynamically modify the application of recommendations after the predetermined period of time. The modification of the application of recommendations may refer to an event occurring that meets a threshold of modification, such as a major life event (e.g., marriage, birth of child, death, payment history, and/or annual income.)

In some embodiments, the modification of the application of recommendations may refer to an adjustment to the automatic application earned reward points for predetermined transactions. In some embodiments, the recommendation generator module 118 may dynamically modify the application of the recommendations by updating the trained machine learning module 120 with an aggregate weight matrix, where the aggregate weight matrix may refer to a plurality of weights associated with the transactions of the account; determining a value proportional to an accumulation of the transactions; and redeeming the value within the account of the user. In certain embodiments, the update of the trained machine learning module 120 utilizing the aggregate weight matrix may provide a value for each transaction within the user-specific usage data. In certain embodiments, the aggregate weight matrix may refer to a modification of the predefined rules of the need multiplier rules engine 124. In some embodiments, the determination of the value proportional to the accumulation of the transactions may refer to a ratio of redeemable points that are earned for each type of transaction over the predetermined period of time. In some embodiments, the redeeming of the value within the account of the user may refer to each redeemable point being applied to the balance of the account, where each redeemable point provides rewards to the user and lowers a risk of credit default.

In some embodiments, the trained machine learning module 120 may determine the correlation between the particular data point (i.e., transaction) within the usage data and the established usage baseline. In some embodiments, the trained machine learning module 120 may dynamically generate a recommendation for subsequent usage based on the correlation between the particular data point and the established usage baseline. In some embodiments, the trained machine learning module 120 may automatically apply the generated recommendation to the account of the user. In some embodiments, the trained machine learning module 120 may dynamically modify the application of the recommendation to the account of the user. In some embodiments, the trained machine learning module 120 may transmit instructions to the computing device 102 to display the application of the recommendation and/or the modification of the application of the recommendation.

In some embodiments, the data output module 122 may output the user-specific usage data for the user in response to monitoring the account of the user for the predetermined period of time. In some embodiments, the data output module 122 may output the correlation between the user-specific usage data and the established usage baseline. In some embodiments, the data output module 122 may output a recommendation for subsequent usage, where the recommendation includes a value applicable to the account of the user. In some embodiments, the data output module 122 may output a result of the automatic application of the generated recommendation. In some embodiments, the data output module 122 may output a dynamic modification to the application of the recommendation in response to an account threshold being met. In some embodiments, the data output module 122 may output a notification detailing the application of the recommendation to the account of the user.

In some embodiments, the non-transient memory 110 may store the user-specific usage data in the server computing device 106. In some embodiments, the non-transient memory 110 may store the output of the recommendation generator module 118. In some embodiments, the non-transient memory 110 may store the output of the trained machine learning module 120. In some embodiments, the non-transient memory 110 may store the determined correlation between the user-specific usage data and the established usage baseline associated with the user. In some embodiments, the non-transient memory 110 may store the recommendation for subsequent usage.

In some embodiments, the processor 108 may obtain usage data associated with the account of the user. In some embodiments, the processor 108 may determine the correlation between a particular data point within the user-specific usage data and the established usage baseline. In some embodiments, the processor 108 may generate a recommendation for subsequent usage based on the determined correlation between the particular data point within the user-specific usage data and the established usage baseline. In some embodiments, the processor 108 may apply the recommendation to the account of the user, where the recommendation is a redeemable value in proportion to the particular data point. In some embodiments, the processor 108 may modify a plurality of predetermined rules based on the application of the recommendation and an account threshold being met and/or exceeded.

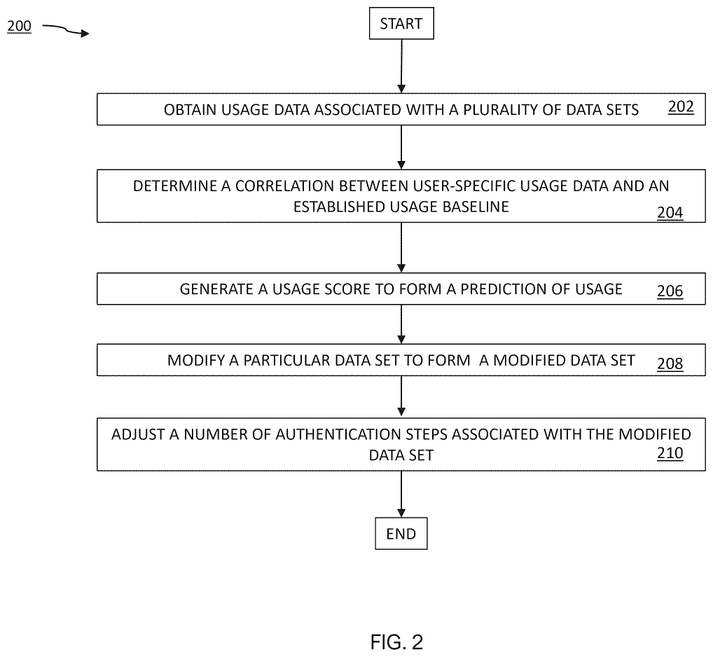

FIG. 2 is a flowchart 200 illustrating operational steps for automatically modifying an account of a user in response to a generated recommendation based on a usage value, in accordance with one or more embodiments of the present disclosure.

In step 202, the illustrative program engine 104 within the computing device 102 may be programmed to obtain usage data associated with a plurality of data sets. In some embodiments, the illustrative program engine 104 may obtain the usage data associated with a plurality of data sets by monitoring transactional activity over a predetermined period of time. In some embodiments, the obtained usage data may refer to user-specific usage data. In certain embodiments, the predetermined period of time may refer to a period with a minimum range of hours to and a maximum range months. In a preferred embodiment, the period of time may refer to three to fourteen days. In some embodiments, the illustrative program engine 104 may obtain the user-specific usage data by continuously monitoring activity associated with the account of the user, where the activity may refer to a plurality of transactions utilizing data transfers stored in the computing device of the user. In some embodiments, the illustrative program engine 104 may identify a type of transaction associated with each transaction in the plurality of transactions and provide a type label to each transaction for optimizing storage within the server computing device 106. In some embodiments, the illustrative program engine 104 may compare each transaction within a particular type of transaction to an aggregate rate matrix to assign a weight to each transaction for a proportional redeemable value based on the need multiplier rules engine 124. In some embodiments, the recommendation generator module 118 may obtain the usage data associated with an account of the user.

In step 204, the illustrative program engine 104 may determine a correlation between one data point and an established usage baseline. In some embodiments, the illustrative program engine 104 may utilize the trained machine learning module 120 to determine the correlation between the set of data points, which includes the user-specific usage data, and the established usage baseline. In certain embodiments, the usage baseline may be established based on historical usage data associated with the account of the user and collected over multiple periods of time prior to obtaining a current user-specific usage data. In some embodiments, the determine the correlation between the user-specific usage data and the established usage baseline by analyzing the user-specific usage data, parsing the user-specific usage data representing each type of transaction (i.e., transaction labels), storing the parsed user-specific usage data in a behavioral model in the form of predetermined transaction rules, and comparing the parsed user-specific usage data to the historical usage data associated with the account of the user. In some embodiments, the recommendation generator module 118 may determine the correlation between the user-specific usage data and the established usage baseline.

In step 206, the illustrative program engine 104 may generate a usage score to form a prediction of usage. In some embodiments, the illustrative program engine 104 may utilize the trained machine learning module 120 to dynamically generate the usage score for the plurality of data sets of the user based on the determined correlation between the user-specific usage data and the established baseline, specifically the set of data points and the established baseline. In certain embodiments, the usage score may provide a prediction on subsequent usage of the user based on the determined correlation between the user-specific usage data and the established baseline. In certain embodiments, the recommendation may refer to an automatic redeemable value to the account of the user. In some embodiments, the recommendation generator module 118 may dynamically generate the recommendation for the account of the user based on the determined correlation between the user-specific usage data and the established baseline.

In step 208, the illustrative program engine 104 may automatically modify a particular data set to form a modified data set. In some embodiments, the illustrative program engine 104 may automatically modify the particular data set based on the generated usage score to the account of the user based on the determined correlation between the user-specific usage data and the established usage baseline. In certain embodiments, the automatic modification of the particular data set associated with the account of the user may refer to a plurality of redeemable values to the account of the user. The redeemable values may refer to an earned point based on an identified purchase within the user-specific usage data, where each earned point refers to an identified transaction that aligns with a predetermined type of purchase and/or an account threshold associated with the account of the user. These predetermined types of purchases and account thresholds may also be included in the predefined rules of the trained machine learning module 120. In some embodiments, the recommendation generator module 118 may automatically apply the generated recommendation to the account of the user based on the determined correlation between the user-specific usage data and the established usage baseline.

In step 210, the illustrative program engine 104 may adjust a number of authentication steps associated with the modified data set. In some embodiments, the illustrative program engine 104 may adjust the number of authentication steps associated with the particular data set based on the usage score after an expiration of the predetermined period of time. In certain embodiments, the adjustment of the authentication sets, whether increase or decrease, may refer to a generated recommendation of the trained machine learning module 120. In some embodiments, the illustrative program engine 104 may dynamically modify the application of the generated recommendation after the predetermined period of time. In some embodiments, the modification of the application of the generated recommendation may occur in response to an event occurring that meets a threshold of modification, such as a major life event. For example, the major life event that may meet the threshold of modification may include marriage, birth of child, death, updated payment history, and/or updated annual income. In some embodiments, the dynamic modification of the application of the generated recommendation may refer to an adjustment to the automatic application earned reward points for predetermined transactions. In certain embodiments, the illustrative program engine 104 may dynamically modify the application of the generated recommendation by updating the trained machine learning module 120 with an aggregate weight matrix, where the aggregate weight matrix may refer to a plurality of weights associated with the transactions of the account; determining a value proportional to an accumulation of the transactions; and redeeming the value within the account of the user. In some embodiments, the recommendation generator module 118 may dynamically modify the application of the generated recommendation after the predetermined period of time.

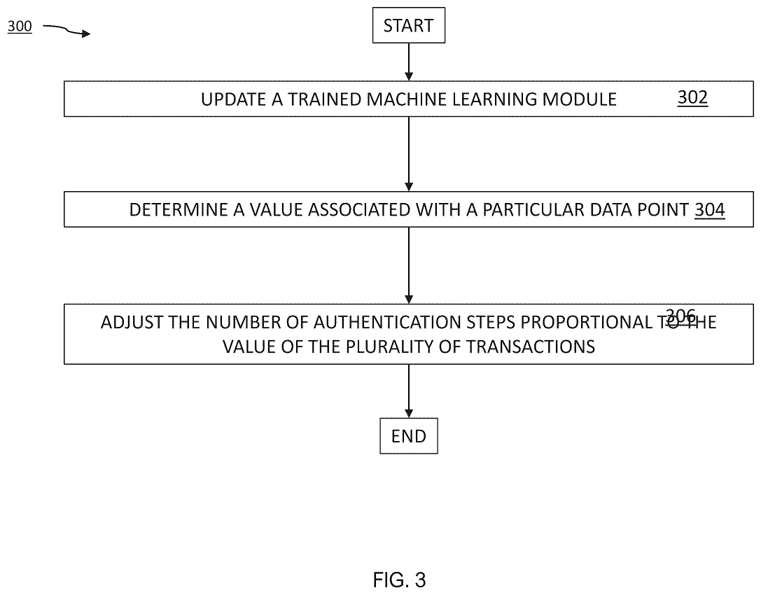

FIG. 3 is a flowchart 300 illustrating operational steps for adjusting a number of authentication steps associated with a particular data set, in accordance with one or more embodiments of the present disclosure.

In step 302, the illustrative program engine 104 may update the trained machine learning module 120. In some embodiments, the illustrative program engine 104 may dynamically update the trained machine learning module 120 with an aggregate weight matrix. In certain embodiments, the aggregate weight matrix may refer to a plurality of weights associated with the transactions of the account. In some embodiments, the trained machine learning module 120 may be updated with the aggregate weight matrix in response to the automatic application of a generated recommendation and prior to the dynamic modification to the predefined rules. In some embodiments, the recommendation generator module 118 may dynamically update the trained machine learning module 120 with an aggregate weight matrix.

In step 304, the illustrative program engine 104 may determine a value associated with the particular data point. In some embodiments, the illustrative program engine 104 may determine the value associated with the particular data point within the user-specific usage data, where the particular data point may refer to a particular transaction that is assigned a weighted value based on the aggregate weight matrix. In some embodiments, the determination of the value proportional to the accumulation of the transactions may refer to a ratio of redeemable points that are earned for each type of transaction over the predetermined period of time. In some embodiments, the recommendation generator module 118 may determine the value associated with the particular data point within the user-specific usage data.

In step 306, the illustrative program engine 104 may adjust the number of authentication steps proportional to the value of the plurality of transactions. In some embodiments, the illustrative program engine 104 may adjust the number of authentications steps, increase or decrease, by the trained machine learning module 120 redeeming the proportional value based on the aggregate weight matrix. In some embodiments, the redeeming of the value within the account of the user may refer to each redeemable point being applied to the balance of the account, where each redeemable point provides rewards to the user and lowers a risk of credit default. In some embodiments, the recommendation generator module 118 may redeem the value based on the aggregate weight matrix.

The material disclosed herein may be implemented in software or firmware or a combination of them or as instructions stored on a machine-readable medium, which may be read and executed by one or more processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; knowledge corpus; stored audio recordings; flash memory devices; electrical, optical, acoustical or other forms of propagated signals (e.g., carrier waves, infrared signals, digital signals, etc.), and others.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, etc.).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, operating system software, middleware, firmware, software modules, routines, subroutines, functions, methods, procedures, software interfaces, application program interfaces (API), instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, etc.).

In some embodiments, one or more of exemplary inventive computer-based systems/platforms, exemplary inventive computer-based devices, and/or exemplary inventive computer-based components of the present disclosure may include or be incorporated, partially or entirely into at least one personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

As used herein, the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. In some embodiments, the server may store transactions and dynamically trained machine learning models. Cloud servers are examples.

In some embodiments, as detailed herein, one or more of exemplary inventive computer-based systems/platforms, exemplary inventive computer-based devices, and/or exemplary inventive computer-based components of the present disclosure may obtain, manipulate, transfer, store, transform, generate, and/or output any digital object and/or data unit (e.g., from inside and/or outside of a particular application) that can be in any suitable form such as, without limitation, a file, a contact, a task, an email, a social media post, a map, an entire application (e.g., a calculator), etc. In some embodiments, as detailed herein, one or more of exemplary inventive computer-based systems/platforms, exemplary inventive computer-based devices, and/or exemplary inventive computer-based components of the present disclosure may be implemented across one or more of various computer platforms such as, but not limited to: (1) FreeBSD™, NetBSD™, OpenBSD™; (2) Linux™; (3) Microsoft Windows™; (4) OS X (MacOS)™; (5) MacOS 11™; (6) Solaris™; (7) Android™; (8) iOS™; (9) Embedded Linux™; (10) Tizen™; (11) WebOS™; (12) IBM i™; (13) IBM AIX™; (14) Binary Runtime Environment for Wireless (BREW) ™; (15) Cocoa (API)™; (16) Cocoa Touch™; (17) Java Platforms™; (18) JavaFX™; (19) JavaFX Mobile;™(20) Microsoft DirectX™; (21). NET Framework™; (22) Silverlight™; (23) Open Web Platform™; (24) Oracle Database™; (25) Qt™; (26) Eclipse Rich Client Platform™; (27) SAP NetWeaver™; (28) Smartface™; and/or (29) Windows Runtime™.

In some embodiments, exemplary inventive computer-based systems/platforms, exemplary inventive computer-based devices, and/or exemplary inventive computer-based components of the present disclosure may be configured to utilize hardwired circuitry that may be used in place of or in combination with software instructions to implement features consistent with principles of the disclosure. Thus, implementations consistent with principles of the disclosure are not limited to any specific combination of hardware circuitry and software. For example, various embodiments may be embodied in many different ways as a software component such as, without limitation, a stand-alone software package, a combination of software packages, or it may be a software package incorporated as a “tool” in a larger software product.

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device. In at least one embodiment, the exemplary recommendation generator module 118 of the present disclosure, utilizing at least one machine-learning model described herein, may be referred to as exemplary software.

In some embodiments, exemplary inventive computer-based systems/platforms, exemplary inventive computer-based devices, and/or exemplary inventive computer-based components of the present disclosure may be configured to handle numerous concurrent transactions/users that may be, but is not limited to, at least 100 (e.g., but not limited to, 100-999), at least 1,000 (e.g., but not limited to, 1,000-9,999) , at least 10,000 (e.g., but not limited to, 10,000-99,999), at least 100,000 (e.g., but not limited to, 100,000-999,999), at least 1,000,000 (e.g., but not limited to, 1,000,000-9,999,999), at least 10,000,000 (e.g., but not limited to, 10,000,000-99,999,999), at least 100,000,000 (e.g., but not limited to, 100,000,000-999,999,999), at least 1,000,000,000 (e.g., but not limited to, 1,000,000,000-999,999,999,999), and so on.

In some embodiments, exemplary inventive computer-based systems/platforms, exemplary inventive computer-based devices, and/or exemplary inventive computer-based components of the present disclosure may be configured to output to distinct, specifically programmed graphical user interface implementations of the present disclosure (e.g., a desktop, a web app., etc.). In various implementations of the present disclosure, a final output may be displayed on a displaying screen which may be, without limitation, a screen of a computer, a screen of a mobile device, or the like. In various implementations, the display may be a holographic display. In various implementations, the display may be a transparent surface that may receive a visual projection. Such projections may convey various forms of information, images, and/or objects. For example, such projections may be a visual overlay for a mobile augmented reality (MAR) application.

As used herein, the term “mobile electronic device,” or the like, may refer to any portable electronic device that may or may not be enabled with location tracking functionality (e.g., MAC address, Internet Protocol (IP) address, or the like). For example, a mobile electronic device can include, but is not limited to, a mobile phone, Personal Digital Assistant (PDA), Blackberry™, Pager, Smartphone, or any other reasonable mobile electronic device.

In some embodiments, the exemplary inventive computer-based systems/platforms, the exemplary inventive computer-based devices, and/or the exemplary inventive computer-based components of the present disclosure may be configured to securely store and/or transmit data (e.g., tokenized PAN numbers, etc.) by utilizing one or more of encryption techniques (e.g., private/public key pair, Triple Data Encryption Standard (3DES), block cipher algorithms (e.g., IDEA, RC2, RC5, CAST and Skipjack), cryptographic hash algorithms (e.g., MD5, RIPEMD-160, RTR0, SHA-1, SHA-2, Tiger (TTH), WHIRLPOOL, RNGs).

The aforementioned examples are, of course, illustrative and not restrictive.

As used herein, the term “user” shall have a meaning of at least one user. In some embodiments, the terms “user”, “subscriber” “consumer” or “customer” should be understood to refer to a user of an application or applications as described herein and/or a consumer of data supplied by a data provider. By way of example, and not limitation, the terms “user” or “subscriber” can refer to a person who receives data provided by the data or service provider over the Internet in a browser session, or can refer to an automated software application which receives the data and stores or processes the data.

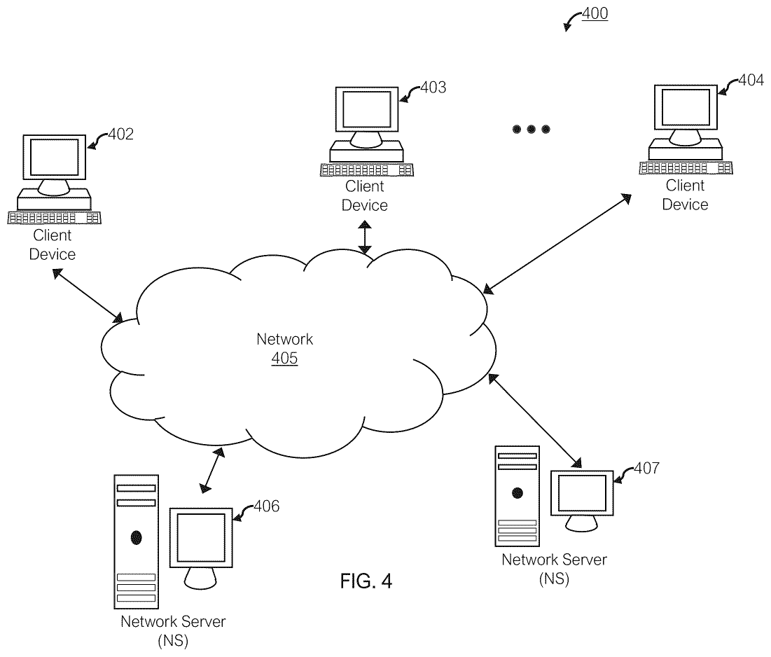

FIG. 4 depicts a block diagram of an exemplary computer-based system/platform 400 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the exemplary inventive computing devices and/or the exemplary inventive computing components of the exemplary computer-based system/platform 400 may be configured to manage a large number of members and/or concurrent transactions, as detailed herein. In some embodiments, the exemplary computer-based system/platform 400 may be based on a scalable computer and/or network architecture that incorporates various strategies for assessing the data, caching, searching, and/or database connection pooling. An example of the scalable architecture is an architecture that is capable of operating multiple servers. In some embodiments, the exemplary inventive computing devices and/or the exemplary inventive computing components of the exemplary computer-based system/platform 400 may be configured to manage the exemplary recommendation generator module 118 of the present disclosure, utilizing at least one machine-learning model described herein.

In some embodiments, referring to FIG. 4, members 402-404 (e.g., clients) of the exemplary computer-based system/platform 400 may include virtually any computing device capable of receiving and sending a message over a network (e.g., cloud network), such as network 405, to and from another computing device, such as servers 406 and 407, each other, and the like. In some embodiments, the member devices 402-404 may be personal computers, multiprocessor systems, microprocessor-based or programmable consumer electronics, network PCs, and the like. In some embodiments, one or more member devices within member devices 402-404 may include computing devices that connect using a wireless communications medium such as cell phones, smart phones, pagers, walkie talkies, radio frequency (RF) devices, infrared (IR) devices, CBs, integrated devices combining one or more of the preceding devices, or virtually any mobile computing device, and the like. In some embodiments, one or more member devices within member devices 402-404 may be devices that are capable of connecting using a wired or wireless communication medium such as a PDA, POCKET PC, wearable computer, a laptop, tablet, desktop computer, a netbook, a video game device, a pager, a smart phone, an ultra-mobile personal computer (UMPC), and/or any other device that is equipped to communicate over a wired and/or wireless communication medium (e.g., NFC, RFID, NBIOT, 3G, 4G, 5G, GSM, GPRS, WiFi, WiMax, CDMA, satellite, ZigBee, etc.). In some embodiments, one or more member devices within member devices 402-404 may run one or more applications, such as Internet browsers, mobile applications, voice calls, videoconferencing, and email, among others. In some embodiments, one or more member devices within member devices 402-404 may be configured to receive and to send web pages, and the like. In some embodiments, an exemplary specifically programmed browser application of the present disclosure may be configured to receive and display graphics, text, multimedia, and the like, employing virtually any web based language, including, but not limited to Standard Generalized Markup Language (SMGL), such as HyperText Markup Language (HTML), a wireless application protocol (WAP), a Handheld Device Markup Language (HDML), such as Wireless Markup Language (WML), WMLScript, XML, JavaScript, and the like. In some embodiments, a member device within member devices 402-404 may be specifically programmed by either Java,. Net, QT, C, C++ and/or other suitable programming language. In some embodiments, one or more member devices within member devices 402-404 may be specifically programmed include or execute an application to perform a variety of possible tasks, such as, without limitation, messaging functionality, browsing, searching, playing, streaming or displaying various forms of content, including locally stored or uploaded messages, images and/or video, and/or games.

In some embodiments, the exemplary network 405 may provide network access, data transport and/or other services to any computing device coupled to it. In some embodiments, the exemplary network 405 may include and implement at least one specialized network architecture that may be based at least in part on one or more standards set by, for example, without limitation, Global System for Mobile communication (GSM) Association, the Internet Engineering Task Force (IETF), and the Worldwide Interoperability for Microwave Access (WiMAX) forum. In some embodiments, the exemplary network 405 may implement one or more of a GSM architecture, a General Packet Radio Service (GPRS) architecture, a Universal Mobile Telecommunications System (UMTS) architecture, and an evolution of UMTS referred to as Long Term Evolution (LTE). In some embodiments, the exemplary network 405 may include and implement, as an alternative or in conjunction with one or more of the above, a WiMAX architecture defined by the WiMAX forum. In some embodiments and, optionally, in combination of any embodiment described above or below, the exemplary network 405 may also include, for instance, at least one of a local area network (LAN), a wide area network (WAN), the Internet, a virtual LAN (VLAN), an enterprise LAN, a layer 3 virtual private network (VPN), an enterprise IP network, or any combination thereof. In some embodiments and, optionally, in combination of any embodiment described above or below, at least one computer network communication over the exemplary network 405 may be transmitted based at least in part on one of more communication modes such as but not limited to: NFC, RFID, Narrow Band Internet of Things (NBIOT), ZigBee, 3G, 4G, 5G, GSM, GPRS, WiFi, WiMax, CDMA, satellite and any combination thereof. In some embodiments, the exemplary network 405 may also include mass storage, such as network attached storage (NAS), a storage area network (SAN), a content delivery network (CDN) or other forms of computer or machine-readable media.

In some embodiments, the exemplary server 406 or the exemplary server 407 may be a web server (or a series of servers) running a network operating system, examples of which may include but are not limited to Microsoft Windows Server, Novell NetWare, or Linux. In some embodiments, the exemplary server 406 or the exemplary server 407 may be used for and/or provide cloud and/or network computing. Although not shown in FIG. 4, in some embodiments, the exemplary server 406 or the exemplary server 407 may have connections to external systems like email, SMS messaging, text messaging, ad content providers, etc. Any of the features of the exemplary server 406 may be also implemented in the exemplary server 407 and vice versa.

In some embodiments, one or more of the exemplary servers 406 and 407 may be specifically programmed to perform, in non-limiting example, as authentication servers, search servers, email servers, social networking services servers, SMS servers, IM servers, MMS servers, exchange servers, photo-sharing services servers, advertisement providing servers, financial/banking-related services servers, travel services servers, or any similarly suitable service-base servers for users of the member computing devices 401-404.

In some embodiments and, optionally, in combination of any embodiment described above or below, for example, one or more exemplary computing member devices 402-404, the exemplary server 406, and/or the exemplary server 407 may include a specifically programmed software module that may be configured to send, process, and receive information (e.g., transactions, VCNs,, etc.) using a scripting language, a remote procedure call, an email, a tweet, Short Message Service (SMS), Multimedia Message Service (MMS), instant messaging (IM), internet relay chat (IRC), mIRC, Jabber, an application programming interface, Simple Object Access Protocol (SOAP) methods, Common Object Request Broker Architecture (CORBA), HTTP (Hypertext Transfer Protocol), REST (Representational State Transfer), or any combination thereof.

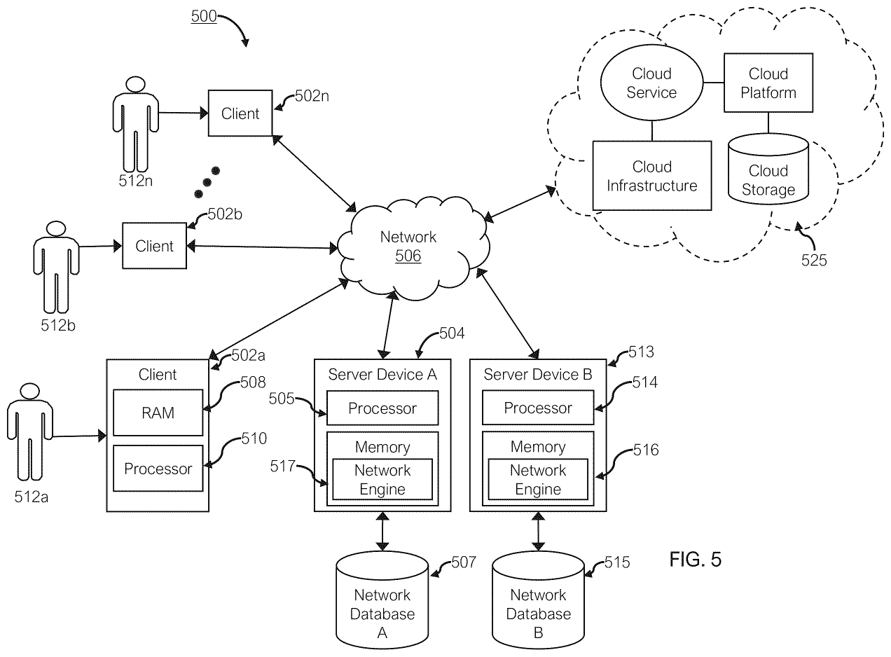

FIG. 5 depicts a block diagram of another exemplary computer-based system/platform 500 in accordance with one or more embodiments of the present disclosure. However, not all of these components may be required to practice one or more embodiments, and variations in the arrangement and type of the components may be made without departing from the spirit or scope of various embodiments of the present disclosure. In some embodiments, the member computing devices 502a, 502b thru 502n shown each at least includes a computer-readable medium, such as a random-access memory (RAM) 508 coupled to a processor 510 or FLASH memory. In some embodiments, the processor 510 may execute computer-executable program instructions stored in memory 508. In some embodiments, the processor 510 may include a microprocessor, an ASIC, and/or a state machine. In some embodiments, the processor 510 may include, or may be in communication with, media, for example computer-readable media, which stores instructions that, when executed by the processor 510, may cause the processor 510 to perform one or more steps described herein. In some embodiments, examples of computer-readable media may include, but are not limited to, an electronic, optical, magnetic, or other storage or transmission device capable of providing a processor, such as the processor 510 of client 502a, with computer-readable instructions. In some embodiments, other examples of suitable media may include, but are not limited to, a floppy disk, CD-ROM, DVD, magnetic disk, memory chip, ROM, RAM, an ASIC, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. In some embodiments, the instructions may comprise code from any computer-programming language, including, for example, C, C++, Visual Basic, Java, Python, Perl, JavaScript, and etc.

In some embodiments, member computing devices 502a through 502n may also comprise a number of external or internal devices such as a mouse, a CD-ROM, DVD, a physical or virtual keyboard, a display, a speaker, or other input or output devices. In some embodiments, examples of member computing devices 502a through 502n (e.g., clients) may be any type of processor-based platforms that are connected to a network 506 such as, without limitation, personal computers, digital assistants, personal digital assistants, smart phones, pagers, digital tablets, laptop computers, Internet appliances, and other processor-based devices. In some embodiments, member computing devices 502a through 502n may be specifically programmed with one or more application programs in accordance with one or more principles/methodologies detailed herein. In some embodiments, member computing devices 502a through 502n may operate on any operating system capable of supporting a browser or browser-enabled application, such as Microsoft™, Windows™, and/or Linux. In some embodiments, member computing devices 502a through 502n shown may include, for example, personal computers executing a browser application program such as Microsoft Corporation's Internet Explorer™, Apple Computer, Inc.'s Safari™, Mozilla Firefox, and/or Opera. In some embodiments, through the member computing client devices 502a through 502n, users, 512a through 512n, may communicate over the exemplary network 506 with each other and/or with other systems and/or devices coupled to the network 506. As shown in FIG. 5, exemplary server devices 504 and 513 may be also coupled to the network 506. Exemplary server device 504 may include a processor 505 coupled to a memory that stores a network engine 517. Exemplary server device 513 may include a processor 514 coupled to a memory 516 that stores a network engine. In some embodiments, one or more member computing devices 502a through 502n may be mobile clients. As shown in FIG. 5, the network 506 may be coupled to a cloud computing/architecture(s) 525. The cloud computing/architecture(s) 525 may include a cloud service coupled to a cloud infrastructure and a cloud platform, where the cloud platform may be coupled to a cloud storage.

In some embodiments, at least one database of exemplary databases 507 and 515 may be any type of database, including a database managed by a database management system (DBMS). In some embodiments, an exemplary DBMS-managed database may be specifically programmed as an engine that controls organization, storage, management, and/or retrieval of data in the respective database. In some embodiments, the exemplary DBMS-managed database may be specifically programmed to provide the ability to query, backup and replicate, enforce rules, provide security, compute, perform change and access logging, and/or automate optimization. In some embodiments, the exemplary DBMS-managed database may be chosen from Oracle database, IBM DB2, Adaptive Server Enterprise, FileMaker, Microsoft Access, Microsoft SQL Server, MySQL, PostgreSQL, and a NoSQL implementation. In some embodiments, the exemplary DBMS-managed database may be specifically programmed to define each respective schema of each database in the exemplary DBMS, according to a particular database model of the present disclosure which may include a hierarchical model, network model, relational model, object model, or some other suitable organization that may result in one or more applicable data structures that may include fields, records, files, and/or objects. In some embodiments, the exemplary DBMS-managed database may be specifically programmed to include metadata about the data that is stored.

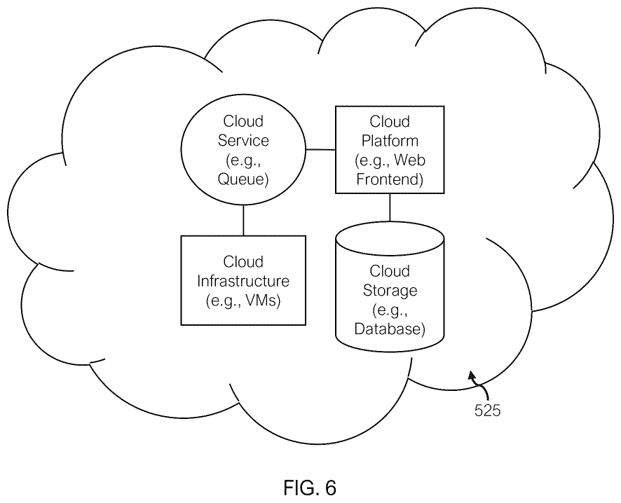

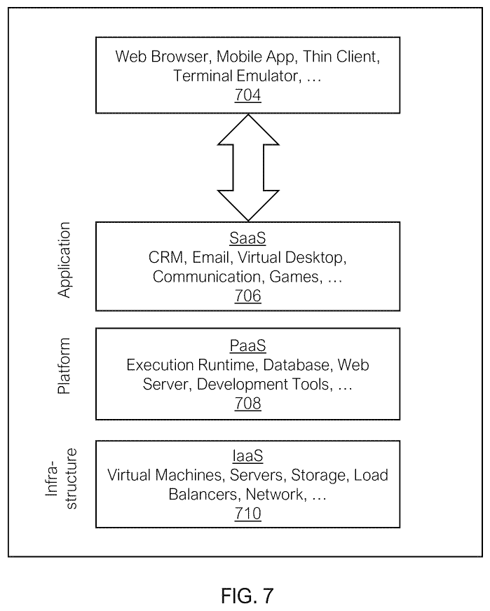

FIG. 6 and FIG. 7 illustrate schematics of exemplary implementations of the cloud computing/architecture(s) in which the exemplary inventive computer-based systems/platforms, the exemplary inventive computer-based devices, and/or the exemplary inventive computer-based components of the present disclosure may be specifically configured to operate. FIG. 6 illustrates an expanded view of the cloud computing/architecture(s) 525 found in FIG. 5. FIG. 7. illustrates the exemplary inventive computer-based components of the present disclosure may be specifically configured to operate in the cloud computing/architecture 525 as a source database 704, where the source database 704 may be a web browser. a mobile application, a thin client, and a terminal emulator. In FIG. 7, the exemplary inventive computer-based systems/platforms, the exemplary inventive computer-based devices, and/or the exemplary inventive computer-based components of the present disclosure may be specifically configured to operate in a cloud computing/architecture such as, but not limiting to: infrastructure a service (IaaS) 710, platform as a service (PaaS) 708, and/or software as a service (SaaS) 706.

In some embodiments, the exemplary inventive computer-based systems/platforms, the exemplary inventive computer-based devices, and/or the exemplary inventive computer-based components of the present disclosure may be configured to utilize one or more exemplary AI/machine learning techniques chosen from, but not limited to, decision trees, boosting, support-vector machines, neural networks, nearest neighbor algorithms, Naive Bayes, bagging, random forests, and the like. In some embodiments and, optionally, in combination of any embodiment described above or below, an exemplary neutral network technique may be one of, without limitation, an artificial recurrent neural network model, a long short-term memory (“LSTM”) model, and a distributed long short-term memory (“DLSTM”) model, feedforward neural network, radial basis function network, recurrent neural network, convolutional network (e.g., U-net) or other suitable network. In some embodiments and, optionally, in combination of any embodiment described above or below, an exemplary implementation of Neural Network may be executed as follows:
i) Define Neural Network architecture/model,
ii) Transfer the input data to the exemplary neural network model,
iii) Train the exemplary model incrementally,
iv) determine the accuracy for a specific number of timesteps,
v) apply the exemplary trained model to process the newly-received input data,
vi) optionally and in parallel, continue to train the exemplary trained model with a predetermined periodicity.

In some embodiments and, optionally, in combination of any embodiment described above or below, the exemplary trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the exemplary trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the exemplary aggregation function may be a mathematical function that combines (e.g., sum, product, etc.) input signals to the node. In some embodiments and, optionally, in combination of any embodiment described above or below, an output of the exemplary aggregation function may be used as input to the exemplary activation function. In some embodiments and, optionally, in combination of any embodiment described above or below, the bias may be a constant value or function that may be used by the aggregation function and/or the activation function to make the node more or less likely to be activated.

At least some aspects of the present disclosure will now be described with reference to the following numbered clauses.

Clause 1. A computer-implemented method may include obtaining, by a processor, usage data associated with a plurality of data sets over a predetermined period of time; determining, by the processor, a correlation between one data point in a plurality of data points associated with each data set within the usage data and an established usage baseline, the established usage baseline is associated with a historical data set; utilizing, by the processor, a trained machine learning module to dynamically generate a usage score for the plurality of data sets based on the correlation between the data point and the established usage baseline to form a prediction of usage data; and automatically modifying, by the processor and in response to the prediction of usage data exceeding a predetermined threshold of usage, a particular data set of the plurality of data sets to form a modified data set, the modified data set including additional authentication steps to perform a plurality of actions.

Clause 2. The method according to clause 1, where the usage data includes account information associated with a particular account tied to a particular computing device.

Clause 3. The method according to clause 1 or 2, where the usage data associated with the plurality of data sets includes user-specific usage data.

Clause 4. The method according to clause 1, 2 or 3, where the predetermined period of time includes a range of time with a minimum limit of minutes and a maximum limit of months.

Clause 5. The method according to clause 1, 2, 3 or 4, where the obtaining the usage data includes: continuously monitoring activity associated with the plurality of data sets, wherein the activity comprises a plurality of transactions utilizing transfers of data stored in the particular data set; identifying a type of transaction associated with each transaction in the plurality of transactions; and comparing each transaction within a particular type of transaction to an aggregate rate matrix to assign a weight to each transaction for a proportional redeemable value.

Clause 6. The method according to clause 1, 2, 3, 4 or 5, where the trained machine learning module includes a need multiplier rules engine.

Clause 7. The method according to clause 1, 2, 3, 4, 5 or 6, where the particular data point within the usage data includes an identified transaction that algins with a predetermined transaction type associated with the trained machine learning module.

Clause 8. The method according to clause 1, 2, 3, 4, 5, 6 or 7, where the usage score includes a proportional value applicable to the plurality of data sets based on an assigned weight via an aggregate weight matrix associated with the need multiplier rules engine.

Clause 9. The method according to clause 1, 2, 3, 4, 5, 6, 7, or 8, where the plurality of data sets includes a transactional data set associated with an external computing device.

Clause 10. The method according to clause 1, 2, 3, 4, 5, 6, 7, 8 or 9, where the established usage baseline includes historical usage data associated with the plurality of data sets collected over multiple periods of time prior to obtaining a current user-specific usage data.

Clause 11. The method according to clause 1, 2, 3, 4, 5, 6, 7, 8, 9 or 10, further including dynamically retraining the machine learning module after an expiration of the predetermined period of time with the usage score.

Clause 12. The method according to clause 1, 2, 3, 4, 5, 6, 7, 8, 9, 10 or 11, where the dynamically retaining the machine learning module by: updating the trained machine learning module with an aggregate weight matrix; determining a value proportional to an accumulation of a plurality of transactions within a particular type of transaction associated with the plurality of data sets; and automatically reducing the number of additional authentications steps proportional to the value of the plurality of transactions.

Clause 13. The method according to clause 1, 2, 3, 4, 5, 6, 7, 8, 9, 10, 11 or 12, where the aggregate weight matrix includes a plurality of weights associated with each type of transaction of the plurality of transactions within the usage data.

Clause 14. The method according to clause 1, 2, 3, 4, 5, 6, 7, 8, 9, 10, 11, 12 or 13, further including generating, via a graphical user interface located within a computing device associated with the user, a notification to detail the modified data set.

Clause 15. A computer-implemented method may include: obtaining, by a processor, usage data associated with a plurality of data sets over a predetermined period of time; determining, by the processor, a correlation between one data point associated with each data set within the usage data and an established usage baseline, the established usage baseline is associated with a historical data set; utilizing, by the processor, a need multiplier rules engine to dynamically generate a usage score for the plurality of data sets based on the correlation between the set of data points and the established usage baseline to form a prediction of usage data; automatically modifying, by the processor and in response to the prediction of usage data exceeding a predetermined threshold of usage, a particular data set of the plurality of data sets to form a modified data set, the modified data set comprising additional authentication steps to perform a plurality of actions; and generating, by the processor and via a graphical user interface located within a computing device, a notification detailing the modified data set.

Clause 16. The method according to clause 15, where the obtaining the usage data includes: continuously monitoring activity associated with the plurality of data set, wherein the activity comprises a plurality of transactions utilizing transfers of data stored in the particular data set; identifying a type of transaction associated with each transaction in the plurality of transactions; and comparing each transaction within a particular type of transaction to an aggregate rate matrix to assign a weight to each transaction for a proportional redeemable value.

Clause 17. The method according to clause 15 or 16, where the need multiplier rules engine comprises a trained machine learning module.

Clause 18. The method according to clause 15, 16, or 17, where the comprising automatically modifying the particular data set by: updating the trained machine learning module with an aggregate weight matrix; determining a value proportional to an accumulation of a plurality of transactions within a particular type of transaction associated with the plurality of data sets; and automatically reducing the number of additional authentications steps proportional to the value of the plurality of transactions.

Clause 19. A system may include: a non-transient computer memory, storing software instructions; at least one processor of a first computing device associated with a user; where, when the processor executes the software instructions, the first computing device is programmed to: obtain usage data associated with a plurality of data sets over a predetermined period of time; determine a correlation between one data point in a plurality of data points associated with each data set within the usage data and an established usage baseline, the established usage baseline is associated with a historical data set; utilize a trained machine learning module to dynamically generate a usage score for the plurality of data sets based on the correlation between the data point and the established usage baseline to form a prediction of usage data; and automatically modify, in response to the prediction of usage data exceeding a predetermined threshold of usage, a particular data set of the plurality of data sets to form a modified data set, the modified data set comprising additional authentication steps to perform a plurality of actions.

Clause 20. The system according to clause 19, the software instructions further include the automatically modify the particular data set by: updating the trained machine learning module with an aggregate weight matrix; determining a value proportional to an accumulation of a plurality of transactions within a particular type of transaction associated with the plurality of data sets; and automatically reducing the number of additional authentications steps proportional to the value of the plurality of transactions.

While one or more embodiments of the present disclosure have been described, it is understood that these embodiments are illustrative only, and not restrictive, and that many modifications may become apparent to those of ordinary skill in the art, including that various embodiments of the inventive methodologies, the inventive systems/platforms, and the inventive devices described herein can be utilized in any combination with each other. Further still, the various steps may be carried out in any desired order (and any desired steps may be added and/or any desired steps may be eliminated).

What is claimed is:

1. A computer-implemented method comprising:
obtaining, by a processor, usage data associated with a plurality of data sets over a predetermined period of time;
determining, by the processor, a correlation between one data point in a plurality of data points associated with each data set within the usage data and an established usage baseline, the established usage baseline is associated with a historical data set;
utilizing, by the processor, a trained machine learning module to dynamically generate a usage score for the plurality of data sets based on the correlation between the data point and the established usage baseline to form a prediction of usage data; and
automatically modifying, by the processor and in response to the prediction of usage data exceeding a predetermined threshold of usage, a particular data set of the plurality of data sets to form a modified data set, the modified data set comprising additional authentication steps to perform a plurality of actions.

2. The method of claim 1, wherein the usage data comprises account information associated with a particular account tied to a particular computing device.

3. The method of claim 1, wherein the usage data associated with the plurality of data sets comprises user-specific usage data.

4. The method of claim 1, wherein the predetermined period of time comprises a range of time with a minimum limit of at minutes and a maximum limit of months.

5. The method of claim 1, wherein the obtaining the usage data comprises:
continuously monitoring activity associated with the plurality of data sets, wherein the activity comprises a plurality of transactions utilizing transfers of data stored in the particular data set;
identifying a type of transaction associated with each transaction in the plurality of transactions; and
comparing each transaction within a particular type of transaction to an aggregate rate matrix to assign a weight to each transaction for a proportional redeemable value.

6. The method of claim 1, wherein the trained machine learning module comprises a need multiplier rules engine.

7. The method of claim 1, wherein the particular data point within the usage data comprises an identified transaction that aligns with a predetermined transaction type associated with the trained machine learning module.

8. The method of claim 1, wherein the usage score comprises a proportional value applicable to the plurality of data sets based on an assigned weight via an aggregate weight matrix associated with a need multiplier rules engine.

9. The method of claim 1, wherein the plurality of data sets comprises at least one transactional data set associated with an external computing device.

10. The method of claim 1, wherein the established usage baseline comprises historical usage data associated with the plurality of data sets collected over multiple periods of time prior to obtaining a current user-specific usage data.

11. The method of claim 1, further comprising dynamically retraining the machine learning module after an expiration of the predetermined period of time with the usage score.

12. The method of claim 11, wherein the dynamically retraining the machine learning module by:
updating the trained machine learning module with an aggregate weight matrix;
determining a value proportional to an accumulation of a plurality of transactions within a particular type of transaction associated with the plurality of data sets; and
automatically reducing a number of additional authentications steps proportional to the value of the plurality of transactions.

13. The method of claim 12, wherein the aggregate weight matrix comprises a plurality of weights associated with each type of transaction of the plurality of transactions within the usage data.

14. The method of claim 1, further comprising generating, via a graphical user interface located within a computing device associated with the user, a notification to detail the modified data set.

15. A computer-implemented method comprising:
obtaining, by a processor, usage data associated with a plurality of data sets over a predetermined period of time;
determining, by the processor, a correlation between one data point associated with each data set within the usage data and an established usage baseline, the established usage baseline is associated with a historical data set;
utilizing, by the processor, a need multiplier rules engine to dynamically generate a usage score for the plurality of data sets based on the correlation between the set of data points and the established usage baseline to form a prediction of usage data;
automatically modifying, by the processor and in response to the prediction of usage data exceeding a predetermined threshold of usage, a particular data set of the plurality of data sets to form a modified data set, the modified data set comprising additional authentication steps to perform a plurality of actions; and
generating, by the processor and via a graphical user interface located within a computing device, a notification detailing the modified data set.

16. The method of claim 15, wherein the obtaining the usage data comprises:
continuously monitoring activity associated with the plurality of data set, wherein the activity comprises a plurality of transactions utilizing transfers of data stored in the particular data set;
identifying a type of transaction associated with each transaction in the plurality of transactions; and
comparing each transaction within a particular type of transaction to an aggregate rate matrix to assign a weight to each transaction for a proportional redeemable value.

17. The method of claim 15, wherein the need multiplier rules engine comprises a trained machine learning module.

18. The method of claim 15, further comprising automatically modifying the particular data set by:
updating a trained machine learning module with an aggregate weight matrix;
determining a value proportional to an accumulation of a plurality of transactions within a particular type of transaction associated with the plurality of data sets; and
automatically reducing a number of additional authentications steps proportional to the value of the plurality of transactions.

19. A system comprises:
a non-transient computer memory, storing software instructions; and
at least one processor of a first computing device associated with a user;
wherein, when the processor executes the software instructions, the first computing device is programmed to:
obtain usage data associated with a plurality of data sets over a predetermined period of time;
determine a correlation between one data point in a plurality of data points associated with each data set within the usage data and an established usage baseline, the established usage baseline is associated with a historical data set;
utilize a trained machine learning module to dynamically generate a usage score for the plurality of data sets based on the correlation between the data point and the established usage baseline to form a prediction of usage data; and
automatically modify, in response to the prediction of usage data exceeding a predetermined threshold of usage, a particular data set of the plurality of data sets to form a modified data set, the modified data set comprising additional authentication steps to perform a plurality of actions.

20. The system of claim 19, wherein the software instructions further comprise the automatically modify the particular data set by:
updating the trained machine learning module with an aggregate weight matrix;
determining a value proportional to an accumulation of a plurality of transactions within a particular type of transaction associated with the plurality of data sets; and
automatically reducing a number of additional authentications steps proportional to the value of the plurality of transactions.
